(19) United States
(12) Patent Application Publication
(10) Pub. No.: US 2015/0356155 A1
(43) Pub. Date: Dec. 10, 2015

(54) ELECTRONIC DEVICE AND METHOD OF PERFORMING SEARCH WITH SEARCH WORD IN ELECTRONIC DEVICE

(71) Applicant: Samsung Electronics Co., Ltd., Suwon-si (KR)

(72) Inventor: Hyeongkyu Nam, Suwon-si (KR)

(21) Appl. No.: 14/735,937

(22) Filed: Jun. 10, 2015

(30) Foreign Application Priority Data
Jun. 10, 2014 (KR) 10-2014-0069849

(51) Int. Cl. G06F 17/30

(52) U.S. Cl. CPC G06F 17/30554; G06F 17/30442; G06F 17/30867; G06F 17/30598

(57) ABSTRACT

A search method of an electronic device includes: displaying a search word area and at least one category area including a category item; acquiring a search word and display the acquired search word in the search word area; matching the search word area with the one or more category areas according to an input of the user; and performing a search with the search word based on a category item included in the matched one or more category areas.

### CROSS-REFERENCE TO RELATED APPLICATION(S) AND CLAIM OF PRIORITY

The present application is related to and claims priority from and the benefit under 35 U.S.C. §119(a) of Korean Patent Application No. 10-2014-0069849, filed on Jun. 10, 2014, which is hereby incorporated by reference for all purposes as if fully set forth herein.

### TECHNICAL FIELD

The present application relates generally to an electronic device and a method of performing a search with a search word in an electronic device.

### BACKGROUND

As the Internet is widely used and information technologies develop, Internet users are looking for a search interface that provides a search result more promptly and more accurately in order to search for desired information. Because the user may collect unnecessary information if he or she searches for desired information only with a search word, he or she may use a method of performing a search with a search word using a category item. Accordingly, the search interfaces may provide a configuration of performing a search through a combination of a search word and a category item without providing a search window through which only a search word may be simply input. If information is searched for by combining a search word and a category item, information that is not desired by the user may be excluded while the search is performed.

### SUMMARY

To address the above-discussed deficiencies, it is a primary object to provide a search with the search word using a category, the category is collectively determined regardless of a desired search word, and accordingly, the configuration of categories cannot be actively used.

Furthermore, in order to perform a search with a search word using category items, the desired category items should be selected and input one by one after the search word is input.

The present disclosure relates to an electronic device and a method of performing a search with a search word, and provides an electronic device that allows categories suitable for the tastes of the user to be set for search words. The present disclosure also provides an electronic device that can intuitively match a search word with a category in order to perform a search with the search word within a short time.

In accordance with an aspect of the present disclosure, there is provided a search method of an electronic device, including: displaying a search word area and at least one category area including a category item; acquiring a search word and display the acquired search word in the search word area; matching the search word area with the one or more category areas according to an input of the user; and performing a search with the search word based on a category item included in the matched one or more category areas.

In accordance with another aspect of the present disclosure, there is provided an electronic device including: a display that displays a search word area and at least one category area including a category item; a processor that makes a control to acquire a search word, match the search word area with the one or more category areas according to an input of the user, and performs a search based on a category item included in the matched one or more category areas.

According to the present disclosure, accuracy in a search result for a search word, which is desired by the user, can be further increased by setting category items associated with search words.

Further, because the user can perform a search with a search word by intuitively selecting a search word area and a category area, convenience of the user who uses the interface can be further increased.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment including an electronic device according to various embodiments of the present disclosure;

FIG. 2 is a block diagram illustrating an electronic device according to various embodiments of the present disclosure.

FIG. 3 is a flowchart illustrating an operation of performing a search with a search word in an electronic device according to various embodiments of the present disclosure;

FIG. 4 is a diagram illustrating a search interface display on a display of the electronic device according to various embodiments of the present disclosure;

FIG. 5 is a diagram illustrating an operation of acquiring a search word by the electronic device;

FIGS. 6A, 6B, 6C and 6D are diagrams illustrating an operation of matching a search word area with one or more category areas according to various embodiments of the present disclosure;

FIG. 7 is a flowchart illustrating an operation of performing a search with a search word by an electronic device according to various embodiments of the present disclosure;

FIGS. 8A to 8B are diagrams illustrating a display in which category items are set based on an acquired search word according to various embodiments of the present disclosure;

FIGS. 9A, 9B and 9C are diagrams illustrating a display in which category items are set based on an acquired search word according to various embodiments of the present disclosure;

FIG. 10 is a diagram illustrating a result screen obtained by performing a search with an acquired search word by the electronic device according to various embodiments of the present disclosure; and

FIG. 11 is a diagram illustrating a system for performing a search with a search word using a search server by the electronic device according to various embodiments of the present disclosure.

### DETAILED DESCRIPTION

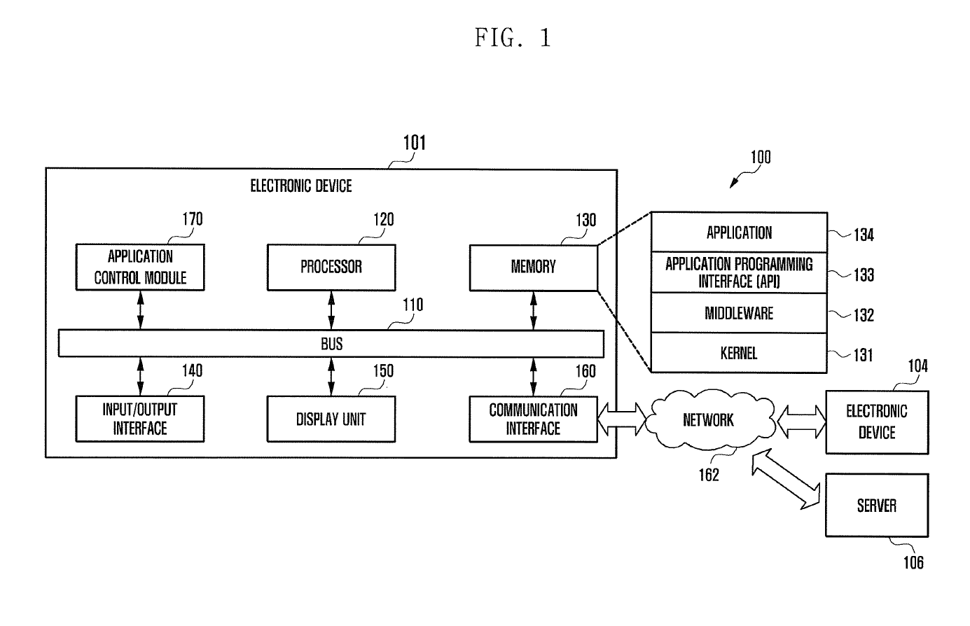

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. In the related art, a user always has to input a particular condition at specific time to search for desired information through search engines or portal sites, and therefore it may be difficult for the user to rapidly and accurately discover required information in real time. In addition, in cases where a user executes a particular application program through an electronic device, a keyword and information that the user wants to discover may be contained in a region that is not displayed on a display of the electronic device among the entire display region of the application program, and therefore it may be difficult for the user to recognize the keyword and information.

Accordingly, in an electronic device for providing information, a method and device is required for effectively transferring and displaying desired information to a user. Various embodiments of the present disclosure provide a method and device for providing information by an electronic device through which a user can receive desired information in real time according to a preset search condition. In addition, various embodiments of the present disclosure provide a method and device for providing information in which a user can recognize, at a glance, a keyword and related information that the user wants to view and movement can be immediately made to the corresponding keyword and the related information.

Hereinafter, embodiments of the present disclosure will be described with reference to the accompanying drawings. The present disclosure may have various modifications and embodiments and thus will be described in detail with reference to specific embodiments illustrated in the drawings. However, it should be understood that there is no intent to limit the present disclosure to the particular forms disclosed herein; rather, the present disclosure should be construed to cover all modifications, equivalents, and/or alternatives falling within the ambit of the disclosure. In the description of the drawings, identical or similar reference numerals are used to designate identical or similar elements.

As used herein, the expression “include” or “may include” refers to the existence of a corresponding function, operation, or element, and does not exclude one or more additional functions, operations, or elements. Also, as used herein, the terms “include” and/or “have” should be construed to denote a certain feature, number, step, operation, element, component or a combination thereof, and should not be construed to exclude the existence or possible addition of one or more other features, numbers, steps, operations, elements, components, or combinations thereof.

Also, as used here, the expression “or” includes any or all combinations of words enumerated together. For example, the expression “A or B” may include A, may include B, or may include both A and B.

In the present disclosure, the expressions “a first”, “a second”, “the first”, “the second”, and the like may modify various elements, but the corresponding elements are not limited by these expressions. For example, the above expressions do not limit the sequence and/or importance of the corresponding elements. The above expressions are used merely for the purpose of distinguishing one element from the other elements. For example, a first user device and a second user device indicate different user devices although both of them are user devices. For example, a first element may be termed a second element, and similarly, a second element may be termed a first element without departing from the scope of the present disclosure.

The terms used in the present disclosure are only used to describe specific embodiments, and are not intended to limit the present disclosure. As used herein, the singular forms are intended to include the plural forms as well, unless the context clearly indicates otherwise.

Unless defined otherwise, all terms used herein, including technical and scientific terms, have the same meaning as those commonly understood by a person of ordinary skill in the art to which the present disclosure pertains. Such terms as those defined in a generally used dictionary are to be interpreted to have the meanings equal to the contextual meanings in the relevant field of the art, and are not to be interpreted to have ideal or excessively formal meanings unless clearly defined in the present disclosure.

An electronic device according to the present disclosure is a device that is configured to provide a user with information. For example, the electronic device can be a combination of one or more of a smartphone, a tablet personal computer, a mobile phone, a video phone, an e-book reader, a desktop personal computer, a laptop personal computer, a netbook computer, a Personal Digital Assistant (PDA), a Portable Multimedia Player (PMP), an MP3 player, a mobile medical device, an electronic bracelet, an electronic necklace, an electronic appcessory, a camera, a wearable device, an electronic clock, a wrist watch, a home appliance (e.g. a refrigerator, an air conditioner, a cleaner, an oven, a microwave oven, a washing machine, a vacuum cleaner, etc.), an artificial intelligent robot, a Television (TV), a Digital Video Disk (DVD) player, an audio player, various medical machines (e.g. a Magnetic Resonance Angiography (MRA), a Magnetic Resonance Imaging (MRI), a Computed Tomography (CT), a tomography camera, a sonography device, etc.), a navigation device, a Global Positioning System (GPS) receiver, an Event Data Recorder (EDR), a Flight Data Recorder (FDR), a set-top box, a TV box (e.g. SAMSUNG HOMESYNC™, APPLE TV®, or GOOGLE TV®), an electronic dictionary, a vehicle infotainment device, electronic equipment for a ship (e.g., navigation equipment for a ship, a gyrocompass, etc.), avionic equipment, a security device, an electronic cloth, an electronic key, a camcorder, a game console, a Head-Mounted Display (HMD), a flat panel display device, an electronic frame, an electronic album, a furniture or a part of a building/structure including a communication function, an electronic board, an electronic signature receiving device, a projector, etc. It is obvious to those skilled in the art that the electronic device according to the present disclosure is not limited to the aforementioned devices.

FIG. 1 illustrates a network environment 100 including an electronic device 101 according to an embodiment of the present disclosure.

Referring to FIG. 1, the electronic device 101 includes a bus 110, a processor 120, a memory 130, an input/output interface 140, a display 150, a communication interface 160, and an application control module 170.

The bus 110 is a circuit that connects the aforementioned elements and transfers communication (for example, a control message) between the aforementioned elements.

The processor 120 receives instructions from the aforementioned other elements (for example, the memory 130, the input/output interface 140, the display 150, the communication interface 160, and the application control module 170) through the bus 110 and decode the received instructions to perform calculation or data processing according to the decoded instructions.

The memory 130 stores instructions or data received from or generated by the processor 120 or the other elements (for example, the input/output interface 140, the display 150, the communication interface 160, and the application control module 170). The memory 130 includes programming modules, such as a kernel 131, a middle ware 132, an Application Programming Interface (API) 133, and applications 134. Each of the programming modules described above can be implemented by software, firmware, and hardware, or a combination of at least two thereof.

The kernel 131 controls or manages system resources (for example, the bus 110, the processor 120, and the memory 130) which are used to execute an operation or a function implemented in the remaining other programming modules, for example, the middle ware 132, the API 133, and the applications 134. In addition, the kernel 131 provides an interface that enables the middle ware 132, the API 133, or the applications 134 to access individual elements of the electronic device 101 for control or management thereof.

The middle ware 132 functions as a relay for allowing the API 133 or the applications 134 to exchange data by communicating with the kernel 131. Furthermore, in regard to task requests received from the applications 134, the middleware 132 performs a control (for example, scheduling or load balancing) for the task requests, by using a method of assigning, to at least one of the applications 134, a priority for using the system resources (for example, the bus 110, the processor 120, and the memory 130) of the electronic device 101.

The API 133 is an interface through which the applications 134 control functions provided by the kernel 131 and the middleware 132, and includes at least one interface or function (for example, instruction) for file control, window control, image processing, or text control.

According to various embodiments, the applications 134 includes a Short Message Service (SMS)/Multimedia Message Service (MMS) application, an e-mail application, a calendar application, an alarm application, a health care application (for example, an application for measuring an amount of exercise or blood sugar), and an environmental information application (for example, an application for providing an atmospheric pressure, humidity, temperature, and the like). Additionally or alternately, the applications 134 include an application related to an information exchange between the electronic device 101 and an external electronic device (for example, an electronic device 104). The application related to the information exchange includes, for example, a notification relay application for transferring specific information to the external electronic device, or a device management application for managing the external electronic device.

For example, the notification relay application includes a function of transferring, to the external electronic device (for example, the electronic device 104), notification information generated from other applications of the electronic device 101 (for example, an SMS/MMS application, an e-mail application, a health management application, an environmental information application, and the like). Additionally or alternatively, the notification relay application receives the notification information from, for example, the external electronic device (for example, the electronic device 104) and provides the received notification information to a user. The device management application manages (for example, install, delete, or update), for example, at least some functions of the external electronic device (for example, the electronic device 104) communicating with the electronic device 101 (for example, turning on/off the external electronic device itself (or some elements thereof) or adjusting brightness (or resolution) of a display), applications operating in the external electronic device, or services provided from the external electronic device (for example, a telephone call service or a message service).

According to various embodiments, the applications 134 include an application designated depending upon an attribute (for example, a type) of the external electronic device (for example, the electronic device 104). For example, in a case where the external electronic device is an MP3 player, the applications 134 include an application related to the reproduction of music. Similarly, in a case where the external electronic device is a mobile medical appliance, the applications 134 include an application related to health care. According to an embodiment, the applications 134 include at least one of an application designated to the electronic device 101 and an application received from the external electronic device (for example, a server 106 or the electronic device 104).

The input/output interface 140 transfers instructions or data, input from a user through an input/output device (for example, a sensor, a keyboard, or a touch screen), to the processor 120, the memory 130, the communication interface 160, or the application control module 170 through, for example, the bus 110. For example, the input/output interface 140 can provide, to the processor 120, data for a user's touch input through the touch screen. Furthermore, through the input/output device (for example, a speaker or a display), the input/output interface 140 outputs instructions or data received from the processor 120, the memory 130, the communication interface 160, or the application control module 170 through the bus 110. For example, the input/output interface 140 can output voice data, processed through the processor 120, to a user through a speaker.

The display 150 displays various types of information (for example, multimedia data or text data) to a user.

The communication interface 160 connects communication between the electronic device 101 and the external electronic device (for example, the electronic device 104 or the server 106). For example, the communication interface 160 can be connected to a network 162 through wireless or wired communication to communicate with the external device. The wireless communication includes at least one of, for example, Wi-Fi, BLUETOOTH® (BT), Near Field Communication (NFC), Global Positioning System (GPS) and cellular communication (for example, Long Term Evolution (LTE), LTE-A, Code Division Multiple Access (CDMA), Wideband CDMA (WCDMA), Universal Mobile Telecommunication System (UMTS), Wireless Broadband (WiBro), Global System for Mobile communication (GSM), and the like. The wired communication includes at least one of, for example, a Universal Serial Bus (USB), a High Definition Multimedia Interface (HDMI), Recommended Standard 232 (RS-232), or a Plain Old Telephone Service (POTS).

According to an embodiment, the network 162 is a telecommunication network. The communication network includes at least one of a computer network, the Internet, the Internet of things, or a telephone network. According to an embodiment, a protocol (for example, a transport layer protocol, data link layer protocol, or a physical layer protocol) for communication between the electronic device 101 and the external device is supported by at least one of the applications 134, the application programming interface 133, the middleware 132, the kernel 131, or the communication interface 160.

The application control module 170 processes at least some pieces of information acquired from the other elements (for example, the processor 120, the memory 130, the input/output interface 140, and the communication interface 160), and provides the processed information to a user through various methods. For example, the application control module 170 recognizes information on connection components included in the electronic device 101, stores the information on the connection components in the memory 130, and executes the applications 134 based on the information on the connection components.

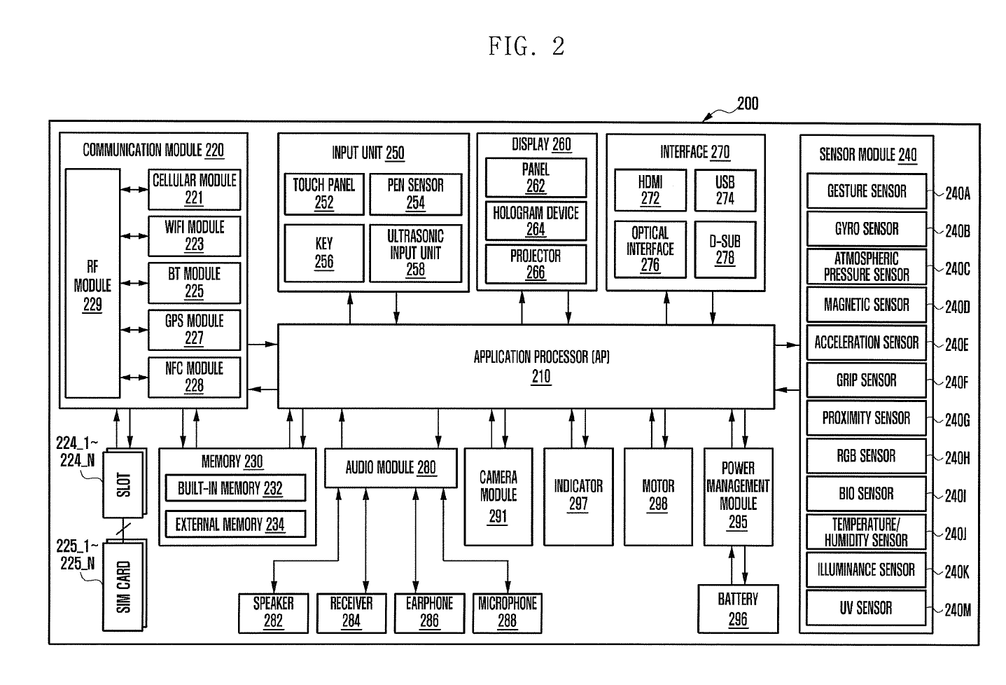

FIG. 2 is a block diagram of an electronic device 200 according to various embodiments of the present disclosure. The electronic device 200 includes, for example, all or some of the electronic device 101 illustrated in FIG. 1.

Referring to FIG. 2, the electronic device 200 includes at least one Application Processor (AP) 210, a communication module 220, a Subscriber Identification Module (SIM) card 225_1˜225-N, a memory 230, a sensor module 240, an input device 250, a display 260, an interface 270, an audio module 280, a camera module 291, a power management module 295, a battery 296, an indicator 297, and a motor 298.

The AP 210 controls a plurality of hardware or software components connected to the AP 210 by driving an operating system or an application program, process various types of data including multimedia data, and perform calculations. The AP 210 is implemented by, for example, a System on Chip (SoC). According to an embodiment, the AP 210 further includes a Graphic Processing Unit (GPU, not illustrated).

The communication module 220 (for example, the communication interface 160) performs data transmission/reception in communication between the electronic device 200 (for example, the electronic device 101 in FIG. 1) and other electronic devices (for example, the electronic device 104 and the server 106 in FIG. 1) connected thereto through a network. According to one embodiment, the communication module 220 includes a cellular module 221, a Wi-Fi module 223, a BT module 225, a GPS module 227, an NFC module 228, and a Radio Frequency (RF) module 229.

The cellular module 221 provides a voice call, a video call, a Short Message Service (SMS), or an Internet service through a communication network (for example, LTE, LTE-A, CDMA, WCDMA, UMTS, WiBro, or GSM). Furthermore, the cellular module 221 distinguishes and authenticates electronic devices within a communication network using a subscriber identification module (for example, the SIM card 225-1˜225_N). According to one embodiment, the cellular module 221 performs at least some functions that the AP 210 provides. For example, the cellular module 221 can perform at least some of the multimedia control function.

According to an embodiment, the cellular module 221 includes a Communication Processor (CP). For example, the cellular module 221 can be implemented as a SoC. Although the elements such as the cellular module 221 (for example, a communication processor), the memory 230, and the power management module 295 are illustrated to be separate from the AP 210 in FIG. 2, the AP 210 includes at least some of the aforementioned elements (for example, the cellular module 221) according to an embodiment.

According to an embodiment, the AP 210 or the cellular module 221 (for example, communication processor) loads instructions or data, received from a non-volatile memory or at least one of the other elements connected thereto, to a volatile memory and processes the loaded instructions or data. Furthermore, the AP 210 or the cellular module 221 stores data received from or generated by at least one of the other elements in a non-volatile memory. The AP 210 and/or the cellular module 221 are the entirety or a part of the processor 120 described above with reference to FIG. 1.

For example, the Wi-Fi module 223, the BT module 225, the GPS module 227, and the NFC module 228 include a processor for processing data transmitted/received through the corresponding module.

Although the cellular module 221, the Wi-Fi module 223, the BT module 225, the GPS module 227, and the NFC module 228 are illustrated as individual blocks in FIG. 2, at least some (for example, two or more) of the cellular module 221, the Wi-Fi module 223, the BT module 225, the GPS module 227, and the NFC module 228 is included within one Integrated Chip (IC) or one IC package according to one embodiment. For example, at least some (for example, the communication processor corresponding to the cellular module 221 and the Wi-Fi processor corresponding to the Wi-Fi module 223) of processors corresponding to the cellular module 221, the Wi-Fi module 223, the BT module 225, the GPS module 227, and the NFC module 228 is implemented as one SoC.

The RF module 229 transmits or receives data, for example, an RF signal. For example, the RF module 229 includes a transceiver, a Power Amp Module (PAM), a frequency filter, a Low Noise Amplifier (LNA), or the like. For example, the RF module 229 further includes a component conductor or a conductive wire for transmitting or receiving an electromagnetic wave in a free space in wireless communication. Although the cellular module 221, the Wi-Fi module 223, the BT module 225, the GPS module 227, and the NFC module 228 share one RF module 229 in FIG. 2, at least one of the cellular module 221, the Wi-Fi module 223, the BT module 225, the GPS module 227, or the NFC module 228 transmits or receives an RF signal through a separate RF module according to one embodiment.

The SIM cards 225_1˜225_N is a card including a subscriber identification module and is inserted into slots 224_{—} 1˜224_N formed in particular positions of the electronic device 200. The SIM cards 225_1˜225_N includes unique identification information (for example, an integrated circuit card identifier (ICCID)) or subscriber information (for example, an international mobile subscriber identity (IMSI)).

The memory 230 (for example, the memory 130 of FIG. 1) includes an internal memory 232 or an external memory 234. The internal memory 232 includes at least one of a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, and the like).

According to an embodiment, the internal memory 232 is a Solid State Drive (SSD). The external memory 234 further includes a flash drive, for example, a Compact Flash (CF), a Secure Digital (SD), a Micro Secure Digital (Micro-SD), a Mini Secure Digital (Mini-SD), an extreme Digital (xD), a memory stick, or the like. The external memory 234 is functionally connected to the electronic device 200 through various interfaces. According to an embodiment, the electronic device 200 further includes a storage device (or storage medium) such as a hard disc drive.

The sensor module 240 measures a physical quantity or detects an operating state of the electronic device 200 and converts the measured or detected information to an electronic signal. For example, the sensor module 240 includes at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a Red/Green/Blue (RGB) sensor), a bio-sensor 240I, a temperature/humidity sensor 240J, an illumination sensor 240K, or an Ultra Violet (UV) sensor 240M. Additionally or alternatively, the sensor module 240 includes an E-nose sensor (not illustrated), an ElectroMyoGraphy (EMG) sensor (not illustrated), an ElectroEncephaloGram (EEG) sensor (not illustrated), an ElectroCardioGram (ECG) sensor (not illustrated), an InfraRed (IR) sensor (not illustrated), an iris sensor (not illustrated), a fingerprint sensor (not illustrated), and the like. The sensor module 240 further includes a control circuit for controlling one or more sensors included therein.

The input device 250 includes a touch panel 252, a pen sensor 254, a key 256, or an ultrasonic input device 258. For example, the touch panel 252 recognizes a touch input through at least one of a capacitive type, a resistive type, an infrared type, or an acoustic wave type. The touch panel 252 further includes a control circuit. The capacitive type touch panel recognizes physical contact or proximity. The touch panel 252 further includes a tactile layer. In this case, the touch panel 252 provides a user with a tactile reaction.

For example, the pen sensor 254 is implemented by using the same or similar method to receiving a user's touch input or by using a separate recognition sheet. For example, the key 256 includes a physical button, an optical key, or a keypad. The ultrasonic input unit 258 identifies data by detecting an acoustic wave with a microphone (for example, microphone 288) of the electronic device 200 through an input unit for generating an ultrasonic signal, and performs wireless recognition. According to an embodiment, the electronic device 200 receives a user input from an external device (for example, a computer or server) connected thereto using the communication module 220.

The display 260 (for example, the display 150 of FIG. 1) includes a panel 262, a hologram device 264, or a projector 266. For example, the panel 262 can be a Liquid Crystal Display (LCD), an Active Matrix Organic Light Emitting Diode (AM-OLED), or the like. For example, the panel 262 can be implemented to be flexible, transparent, or wearable. The panel 262 is formed to be a single module with the touch panel 252. The hologram device 264 is a three dimensional image in the air by using interference of light. The projector 266 projects light onto a screen to display an image. For example, the screen can be located inside or outside the electronic device 200. According to one embodiment, the display 260 further includes a control circuit for controlling the panel 262, the hologram device 264, or the projector 266.

For example, the interface 270 includes a High-Definition Multimedia Interface (HDMI) 272, a Universal Serial Bus (USB) 274, an optical interface 276, or a D-subminiature (D-sub) 278. For example, the interface 270 can be included in the communication interface 160 illustrated in FIG. 1. Additionally or alternatively, the interface 270 includes, for example, a Mobile High-definition Link (MHL) interface, a Secure Digital (SD)/Multi-Media Card (MMC) interface, or an Infrared Data Association (IrDA) standard interface.

The audio module 280 bilaterally converts a sound and an electrical signal. For example, at least some elements of the audio module 280 can be included in the input/output interface 140 illustrated in FIG. 1. For example, the audio module 280 processes voice information input or output through a speaker 282, a receiver 284, earphones 286, or a microphone 288.

According to one embodiment, the camera module 291 is a device that can capture still and moving images, and includes one or more image sensors (for example, a front sensor or a rear sensor), a lens (not illustrated), an image signal processor (ISP, not illustrated), or a flash (for example, an LED or a xenon lamp, not illustrated).

The power management module 295 manages power of the electronic device 200. Although not illustrated, the power management module 295 includes, for example, a Power Management Integrated Circuit (PMIC), a charger Integrated Circuit (IC), or a battery or fuel gauge.

For example, the PMIC can be mounted to an integrated circuit or a SoC semiconductor. Charging methods are classified into a wired charging method and a wireless charging method. The charger IC charges a battery and prevent introduction of over-voltage or over-current from a charger. According to one embodiment, the charger IC includes a charger IC for at least one of the wired charging method and the wireless charging method. A magnetic resonance type, a magnetic induction type, or an electromagnetic type are exemplified as the wireless charging method, and an additional circuit for wireless charging, such as a coil loop circuit, a resonance circuit, a rectifier circuit, and the like can be added.

For example, the battery fuel gauge can measure the remaining amount of battery 296, a charging voltage and current, or temperature. The battery 296 stores or generates electricity and supplies power to the electronic device 200 using the stored or generated electricity. For example, the battery 296 includes a rechargeable battery or a solar battery.

The indicator 297 displays a particular state of the electronic device 200 or a part thereof (for example, the AP 210), for example, a boot-up state, a message state, a charging state, or the like. A motor 298 converts an electrical signal into a mechanical vibration. Although not illustrated, the electronic device 200 includes a processing device (for example, a GPU) for supporting a mobile TV. For example, the processing unit for supporting a mobile TV processes media data according to, for example, a standard of Digital Multimedia Broadcasting (DMB), Digital Video Broadcasting (DVB), media flow, or the like.

The above described components of the electronic device according to various embodiments of the present disclosure cab be formed of one or more components, and a name of a corresponding component element can be changed based on the type of electronic device. The electronic device according to the present disclosure includes at least one of the above-described elements. Some of the above-described elements may be omitted from the electronic device, or the electronic device further includes additional elements. Further, some of the components of the electronic device according to the present disclosure can be combined to be one entity, which can perform the same functions as those of the components before the combination.

The term “module” used in the present disclosure may refer to, for example, a unit including one or more combinations of hardware, software, and firmware. The “module” can be interchangeably used with a term, such as unit, logic, logical block, component, or circuit. The “module” can be the smallest unit of an integrated component or a part thereof. The “module” can be the smallest unit that performs one or more functions or a part thereof. The “module” can be mechanically or electronically implemented. For example, the “module” according to the present disclosure includes at least one of an Application-Specific Integrated Circuit (ASIC) chip, a Field-Programmable Gate Arrays (FPGA), or a programmable-logic device for performing operations which has been known or are to be developed hereinafter.

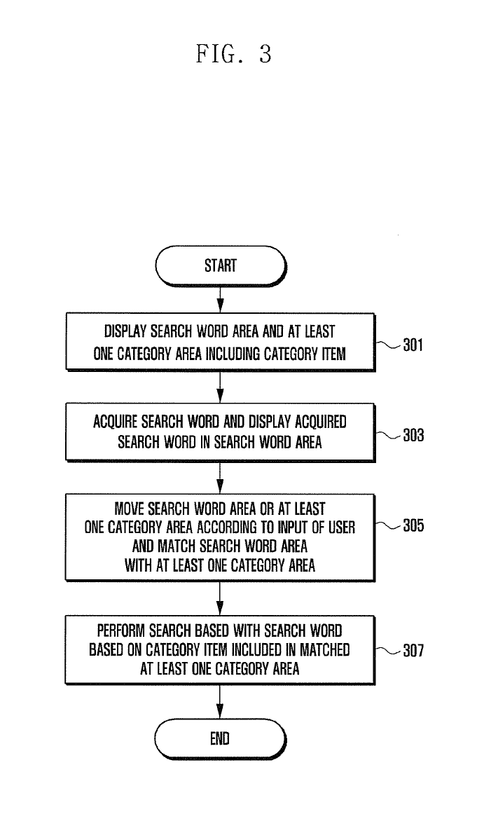

FIG. 3 is a flowchart illustrating an operation of performing a search with a search word in an electronic device 200 according to various embodiments of the present disclosure;

Referring to FIG. 3, the electronic device 200 displays a search word area and at least one category area including a category item in operation 301.

According to an embodiment of the present disclosure, the search word area is an area for displaying a search word acquired by the user, and is matched with the category area including the category item to be searched for. The search word area can have various shapes, such as a triangular shape and a quadrangular shape, as well as a concentrically circular shape and an elliptical shape at various locations. Furthermore, the search word area can have various colors, various sizes, and various contrasts. The category area is an area including a category item, and a plurality of category areas is provided. The category area can have various shapes, such as a triangular shape and a quadrangular shape as well as a concentrically circular shape and an elliptical shape. Furthermore, the category area can have various colors, various sizes, and various contrasts at various locations.

The electronic device 200 acquires a search word and displays the acquired search word in the search word area in operation 303. The electronic device 200 acquires a search word from the user through an input unit 250. The electronic device 200 receives a handwritten letter input or a virtual keypad input from the user through a touch panel 252 included in the input unit 250 in order to acquire a search word. The electronic device 200 receives a written letter input from the user through a pen sensor 254 included in the input unit 250 in order to acquire a search word. The electronic device 200 receives a key input from the user through a key 256 included in the input unit 250 in order to acquire a search word. The electronic device 200 receives an input in the form of an ultrasonic signal from the user through an ultrasonic input unit 258 included in the input unit 250 in order to acquire a search word. The electronic device 200 acquires a search word from the user through a microphone 288. When acquiring a search word from the user through the microphone 288, the electronic device 200 converts a search word including a voice message into a text message to display the converted text message in a search word area.

The electronic device 200 moves a search word area or at least one category area according to an input of the user to match the search word area with the one or more category areas in operation 305. For example, the electronic device 200 can match a search word area with a first category area according to an input of the user. Furthermore, the electronic device 200 matches a search word area with a first category area and a second category area according to an input of the user. In addition, the electronic device 200 matches a search word area with a first category area, a third category area, and a fourth category area according to an input of the user. The matching method includes a method of moving at least one category area and providing at least a part of the category area in a search word area. The matching method includes a method of moving a search word area and providing at least a part of the search word area in at least one category area.

The electronic device 200 performs a search with a search word based on a category item included in the matched one or more category areas in operation 307. For example, when the search word area is matched with the first category area, the electronic device 200 searches for a search word in the category item included in the first category area. When the search word area is matched with the first category area and the second category area, the electronic device 200 acquires a logical product (AND condition) of a category item included in the first category area and a category item included in the second category item to perform a search with a search word. When the search word area is matched with the first category area and the second category area, the electronic device 200 acquires a logical dot (OR condition) of a category item included in the first category area and a category item included in the second category item to perform a search with a search word.

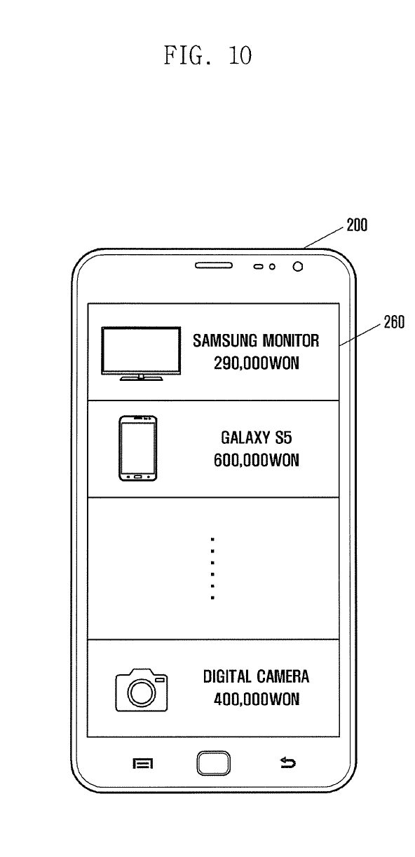

After the search is ended, the electronic device 200 displays the search result on a display 260. As illustrated in FIG. 10, the search result is the same as a configuration of a webpage provided by a search engine.

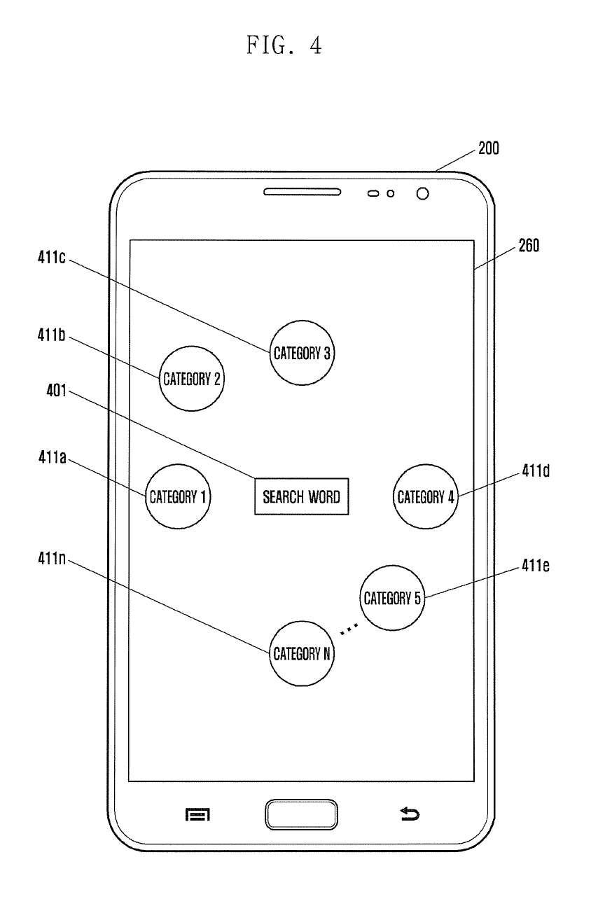

FIG. 4 is a diagram illustrating a search interface display on a display 260 of the electronic device 200 according to various embodiments of the present disclosure.

The search interface includes one or more category areas 411a to 411n including a category item and a search word area 401. The electronic device 200 displays a search interface through the display 260. The electronic device 200 acquires a search word from the user and displays the acquired search word in the search word area 401. The electronic device 200 acquires a search word from the user through an input unit 250. The electronic device 200 receives a handwritten letter input or a virtual keypad input from the user through a touch panel 252 included in the input unit 250 to acquire a search word. The electronic device 200 receives a written letter input from the user through a pen sensor 254 included in the input unit 250 to acquire a search word. The electronic device 200 receives a key input from the user through a key 256 included in the input unit 250 to acquire a search word. The electronic device 200 receives an input in the foam of an ultrasonic signal from the user through an ultrasonic input unit 258 included in the input unit 250 to acquire a search word. The electronic device 200 acquires a search word from the user through a microphone 288. When acquiring a search word from the user through the microphone 288, the electronic device 200 converts a search word including a voice message into a text message to display the converted text message in a search word area.

Each of the one or more category areas 411a to 411n includes a category item. For example, a first category area 411a includes a category item such as shopping. A second category area 411b includes a category item such as news. A third category area 411c includes a category item such as sports. A fourth category area 411d includes a category item such as music. A fifth category area 411e includes a category item such as musicals. An n-th category area 411n includes a specific category item.

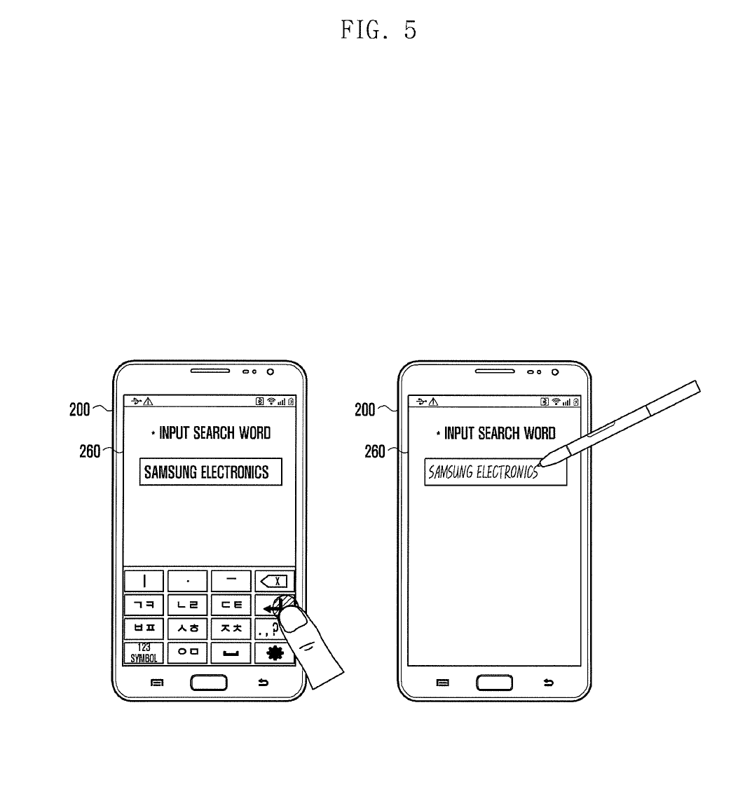

FIG. 5 is a diagram illustrating an operation of acquiring a search word by the electronic device 200.

Referring to FIG. 5, the electronic device 200 acquires a search word from the user through an input unit 250. For example, the electronic device 200 receives a virtual keypad input from the user through a touch panel 252 included in the input unit 250 to acquire a search word. The electronic device 200 receives a written letter input from the user through a pen sensor 254 included in the input unit 250 to acquire a search word.

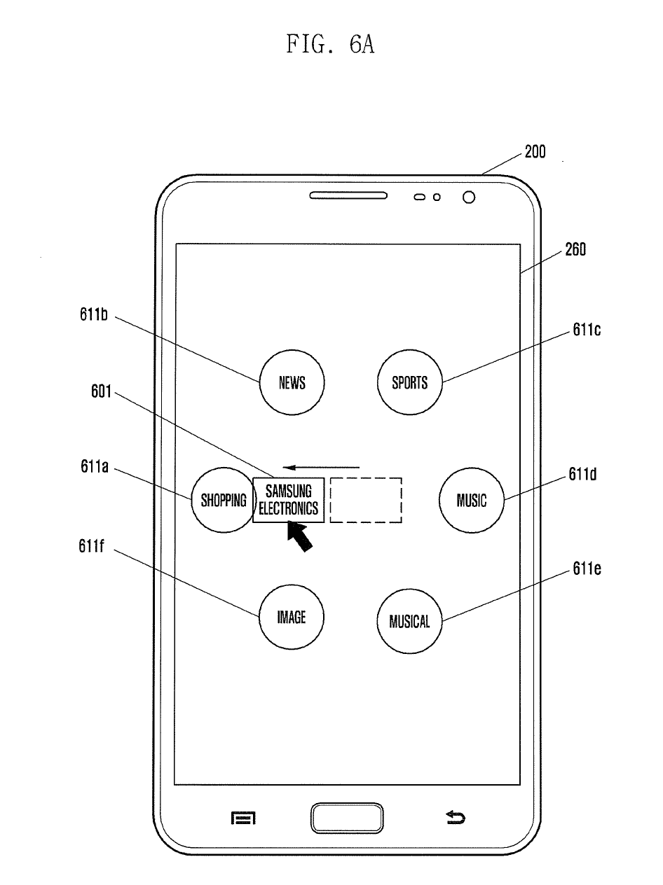

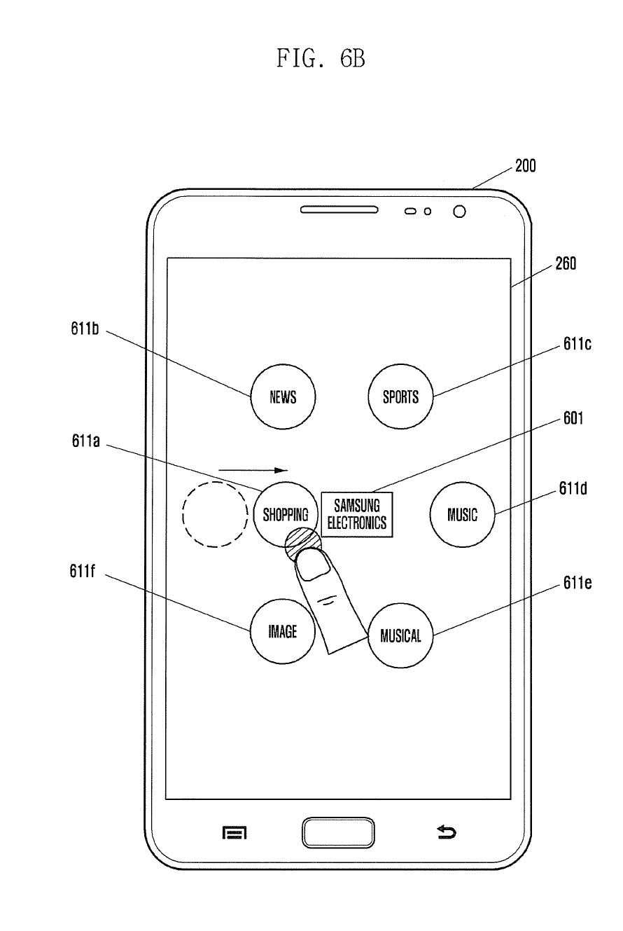

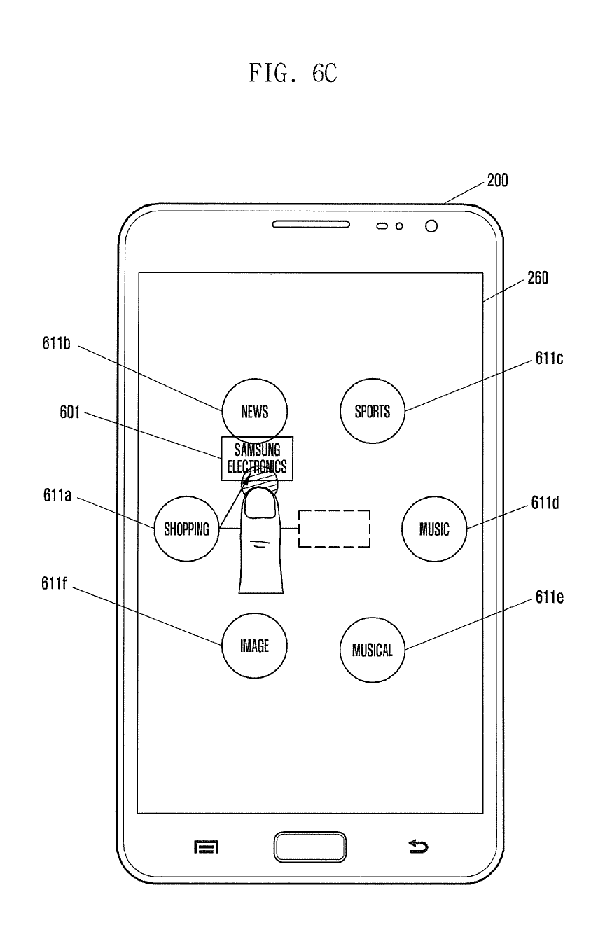

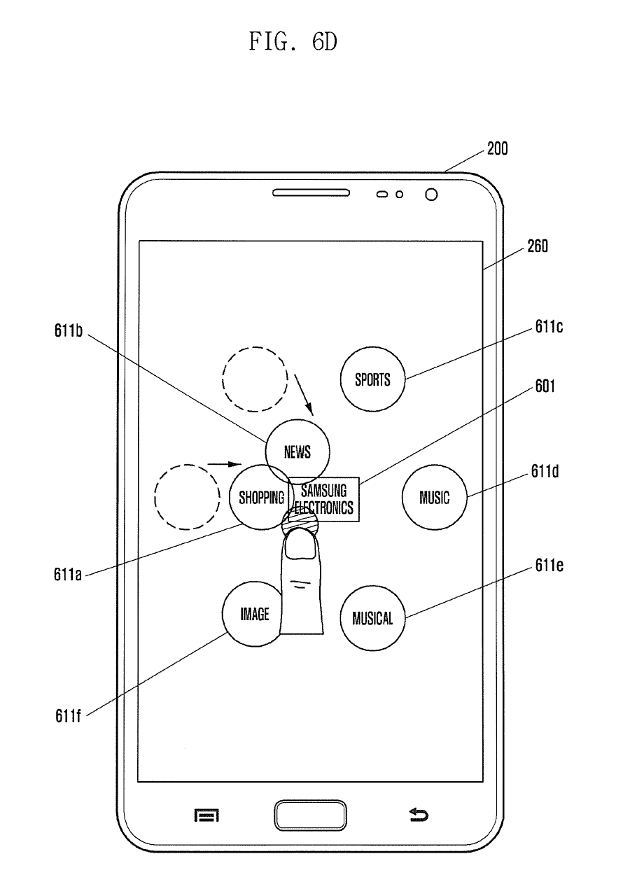

FIGS. 6A to 6D are diagrams illustrating an operation of matching a search word area with one or more category areas according to various embodiments of the present disclosure;

Referring to FIG. 6A, the electronic device 200 acquires a search word from the user. The electronic device 200 displays the acquired search word in a search word area 601. The electronic device 200 moves the search word area 601 or one or more category areas 611a to 611f and matches the search word area 601 with the one or more category areas 611a. For example, when the acquired search word is “Samsung Electronics” and a category item included in the first category area 611a is shopping, the electronic device 200 matches the search word area 601 with the shopping category item included in the first category area 611a according to an input of the user. The input of the user includes a form in which a point is dragged using a mouse or through as finger touch, a scroll form, and a swipe form. In the matching method, the electronic device 200 moves the search word area 601 according to an input of the user and provide at least a part of the search word area 601 in the one or more category areas. For example, the electronic device 200 moves the search word area 601 that displays the search word of “Samsung Electronics” and provide at least a part of the search word area 601 in the first category area 611a including a category item of shopping. If the search word area 601 is matched with the first category area 611a, the electronic device 200 performs a search with a search word of “Samsung Electronics” in the category item of shopping included in the first category area 611a.

Referring to FIG. 6B, the electronic device 200 moves one or more category areas 611a and 611f according to an input of the user and provide at least a part of the moved one or more category areas 611a to 611f in the search word area 601. For example, the electronic device 200 can touch and drag the first category area 611a including a category item of shopping and provide at least a part of the moved first category area 611a in the search word area 601 that displays a search word of “Samsung Electronics.” If the search word area 601 is matched with the first category area 611a, the electronic device 200 performs a search with a search word of “Samsung Electronics” in the category item of shopping included in the first category area 611a.

Referring to FIG. 6C, the electronic device 200 moves the search word area 601 until the input of the user is ended and provide at least a part of the search word area in two or more category areas. For example, the electronic device 200 can touch and drag the search word area 601 that displays the search word of “Samsung Electronics” and provide at least a part of the search word area 601 in the first category area 611a including a category item of shopping and the second category area 611b including news. If the search word area 601 is matched with the first category area 611a and the second category area 611b, the electronic device 200 performs a search with a search word of “Samsung Electronics” in consideration of both the category item of shopping included in the first category area 611a and the category item of news included in the second category area 611b.

Referring to FIG. 6D, the electronic device 200 moves the two or more category areas and provides at least a part of a category area in a search word area. For example, the electronic device 200 touches and drags the first category area 611a including a category item of shopping and the second category area 611b including a category item of news and provides at least a part of the first category area 611a and the second category area 611b in the search word area 601. If the search word area 601 is matched with the first category area 611a and the second category area 611b, the electronic device 200 performs a search with a search word of “Samsung Electronics” in consideration of both the category item of shopping included in the first category area 611a and the category item of shopping included in the second category area 611b.

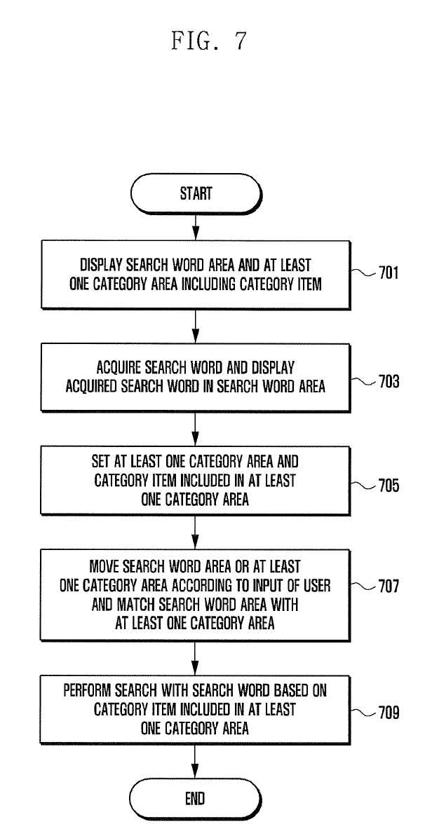

FIG. 7 is a flowchart illustrating an operation of performing a search with a search word by an electronic device 200 according to various embodiments of the present disclosure.

Referring to FIG. 7, the electronic device 200 displays a search word area and at least one category area including a category item in operation 701. The electronic device 200 acquires a search word and displays the acquired search word in operation 703. The electronic device 200 acquires a search word from the user through an input unit 250. The electronic device 200 receives a handwritten letter input or a virtual keypad input from the user through a touch panel 252 included in the input unit 250 to acquire a search word. The electronic device 200 receives a written letter input from the user through a pen sensor 254 included in the input unit 250 to acquire a search word. The electronic device 200 receives a key input from the user through a key 256 included in the input unit 250 to acquire a search word. The electronic device 200 receives an input in the form of an ultrasonic signal from the user through an ultrasonic input unit 258 included in the input unit 250 to acquire a search word. The electronic device 200 acquires a search word from the user through a microphone 288. When acquiring a search word from the user through the microphone 288, the electronic device 200 converts a search word including a voice message into a text message to display the converted text message in a search word area.

The electronic device 200 sets one or more category areas and category items included in the one or more category areas based on the search word acquired in operation 705. The electronic device 200 associates the search word acquired from the user with one or more category areas including category items in order to set the category areas and the category items. The electronic device 200 associates the search word with one or more category areas including category items based on the number of searches for a search word and the search result for the search word. For example, the electronic device 200 can store the number of searches for a search word, and can store the history of the category item selected by the user in the search result for the search word. The electronic device 200 configures one or more category areas including independent category items for search words based on the stored numbers of searches for the search words and the search results for the search words. The electronic device 200 acquires a search word from the user and set category areas including category items associated with the acquired search word. For example, when a specific search word is acquired from the user, the electronic device 200 can set at least one of the number, the locations, the sizes, the colors, and the contrasts of the category areas associated with the acquired search word and display the set at least one of the number, the locations, the sizes, the colors, and the contrasts of the category areas.

The electronic device 200 moves a search word area or at least one category area according to an input of the user to match the search word area with the at least one category area in operation 707. For example, the electronic device 200 can match a search word area with a first category area according to an input of the user. Furthermore, the electronic device 200 can match a search word area with a first category area and a second category area according to an input of the user. In addition, the electronic device 200 can match a search word area with a first category area, a third category area, and a fourth category area according to an input of the user. The matching method includes a method of moving at least one category area and including at least a part of the category area in a search word area. The matching method includes a method of moving a search word area and including at least a part of the search word area in at least one category area.

The electronic device searches for a search word based on a category item included in the matched at least one category area in operation 709. For example, when the search word area is matched with the first category area, the electronic device 200 can search for a search word in the category item included in the first category area. When the search word area is matched with the first category area and the second category area, the electronic device 200 can perform a logical product (AND condition) on a category item included in the first category area and a category item included in the second category item to perform a search with a search word. When the search word area is matched with the first category area and the second category area, the electronic device 200 acquires a logical dot (OR condition) of a category item included in the first category area and a category item included in the second category item to perform a search with a search word. After the search is ended, the electronic device 200 displays the search result on a display 260. As illustrated in FIG. 10, the search result is the same as a configuration of a webpage provided by a search engine.

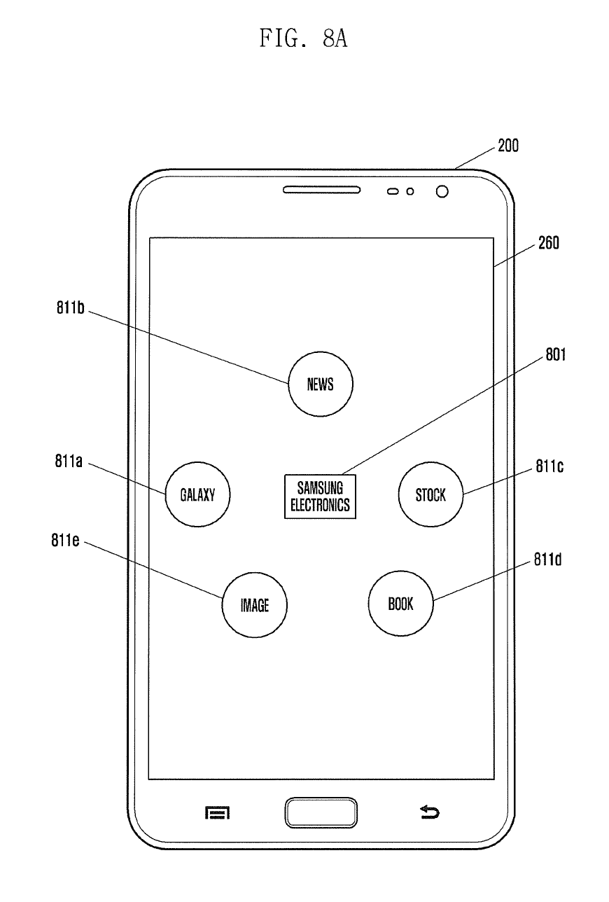

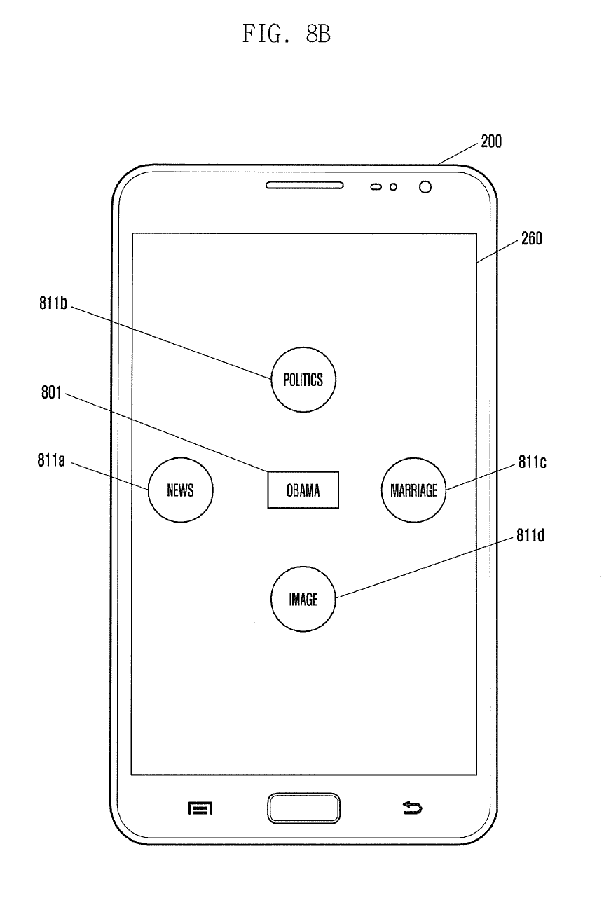

FIGS. 8A to 8B are diagrams illustrating a display 260 in which category items are set based on an acquired search word according to various embodiments of the present disclosure.

Referring to FIG. 8A, the electronic device 200 displays a search word area 801 that displays an acquired search word and one or more category areas 811a to 811f including category items. The electronic device 200 sets the initial states of the category areas and the category items into predetermined default states as illustrated in FIG. 6A. The electronic device 200 receives the initial states of the category areas and the category items from the user and set the received initial states. The electronic device 200 sets the associated category areas based on the search word acquired from the user. For example, when the initial category areas associated with the search word of “Samsung Electronics” are shopping, news, sports, music, musicals, and an image, the search word of “Samsung Electronics” is set in association with a new category based on the number of searches for the search word and the search result. When the user performs a search with a search word of “Samsung Electronics” and performs a search with a search word of “Galaxy” a predetermined number of times in the shopping category item 811a, the electronic device 200 changes and sets the shopping category item 811a into “Galaxy.” Referring to FIG. 6A, when the user performs a search with a search word of “Samsung Electronics” and does not perform a search the music category item 611d a predetermined number of times, the electronic device 200 deletes the music category item 611d.

Referring to FIG. 8B, the electronic device 200 displays a search word area 801 that displays an acquired search word and one or more category areas 811a to 811d including category items. When acquiring a search word from the user, the electronic device 200 sets the category areas associated with the search word. For example, when acquiring a search word of “Obama” from the user, the electronic device 200 can set category areas, including category items of news, politics, marriage, and an image, associated with the corresponding search word. The electronic device 200 sets a category item and a category area based on the number of searches for a search word and a search result for the search word. For example, when the user performs a search on the marriage of “Obama” a predetermined number of times to collect information, the electronic device 200 generates a category item of marriage and associate the generated category item with the search word of “Obama.”

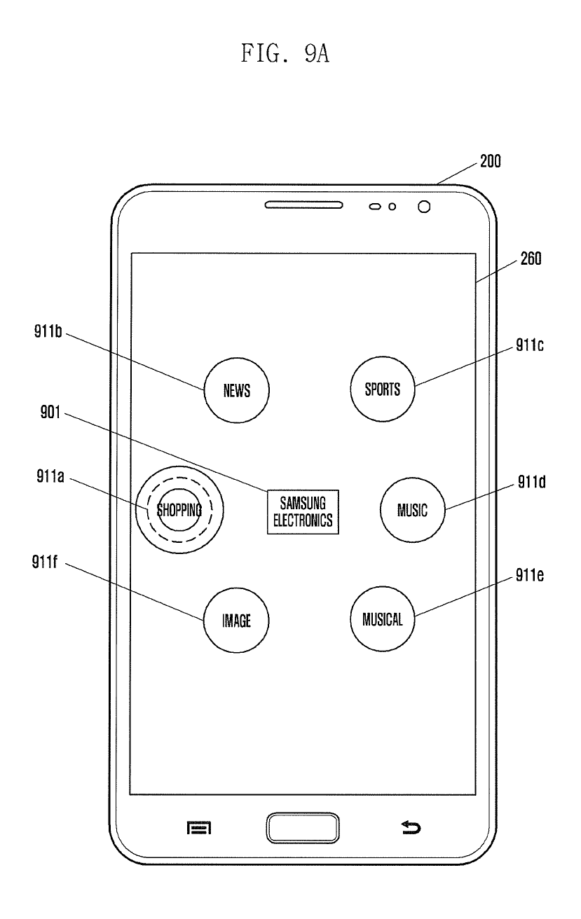

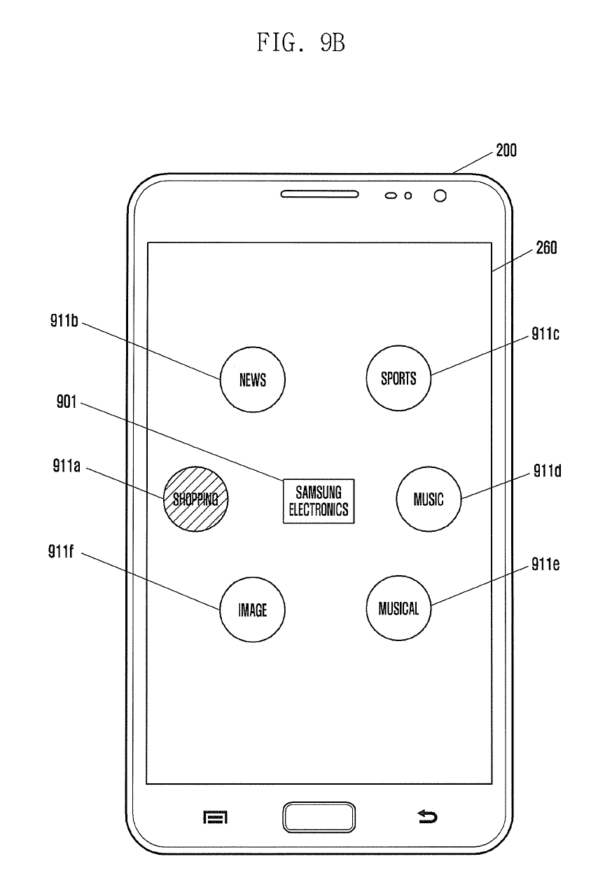

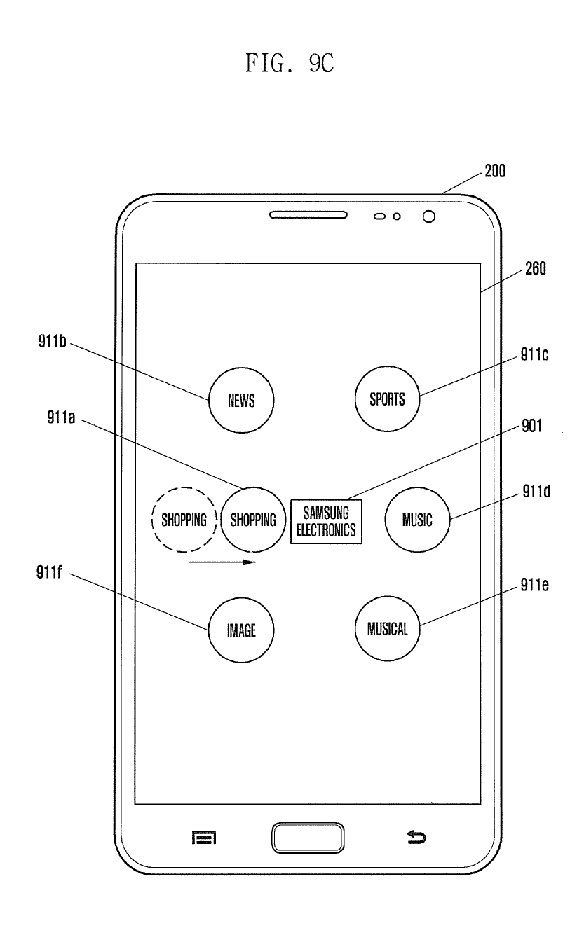

FIGS. 9A to 9C are diagrams illustrating a display 260 in which category items are set based on an acquired search word according to various embodiments of the present disclosure. The electronic device 200 sets at least one of the number, the locations, the sizes, the colors, and the contrasts of one or more category areas based on the number of searches for a search word and the search result.

Referring to FIG. 9A, the electronic device 200 changes and sets the sizes of the category areas based on the number of searches for the search words and the search result for the search words. For example, if the user performs a search with a search of “Samsung Electronics” to search for information related to shopping a predetermined number of times, the electronic device 200 expands the range of an area that displays the category area 911a including a category item of shopping. For example, if the user does not perform a search with a search of “Samsung Electronics” to search for information related to shopping a predetermined number of times, the electronic device 200 reduces or eliminate the range of an area that displays the category area 911a including a category item of shopping.

Referring to FIG. 9B, the electronic device 200 sets the contrast of the category area based on the number of searches for the search words and the search result for the search words. For example, if the user performs a search with a search of “Samsung Electronics” to search for information related to shopping a predetermined number of times, the electronic device 200 adjusts and sets the contrast of the category area 911a including a category item of shopping for the number of times.

Referring to FIG. 9C, the electronic device 200 sets the location of the category area based on the number of searches for the search words and the search result for the search words. For example, if the user performs a search with a search of “Samsung Electronics” to search for information related to shopping a predetermined number of times, the electronic device 200 locates the category area 911a including the category item of shopping near the search word area 901. The electronic device 200 disposes one or more category areas at various locations based on the acquired search word.

FIG. 10 is a diagram illustrating a result screen obtained by searching for an acquired search word by the electronic device 200 according to various embodiments of the present disclosure.

The electronic device 200 acquires a search word of “Samsung Electronics” from the user and matches a search word area that displays the search word with a category area including a category item of shopping. The electronic device 200 performs a search with a search word of “Samsung Electronics” in a category item of shopping. Referring to FIG. 10, the electronic device 200 displays the search result obtained based on a search word of “Samsung Electronics” and a category item of shopping on the display 260.

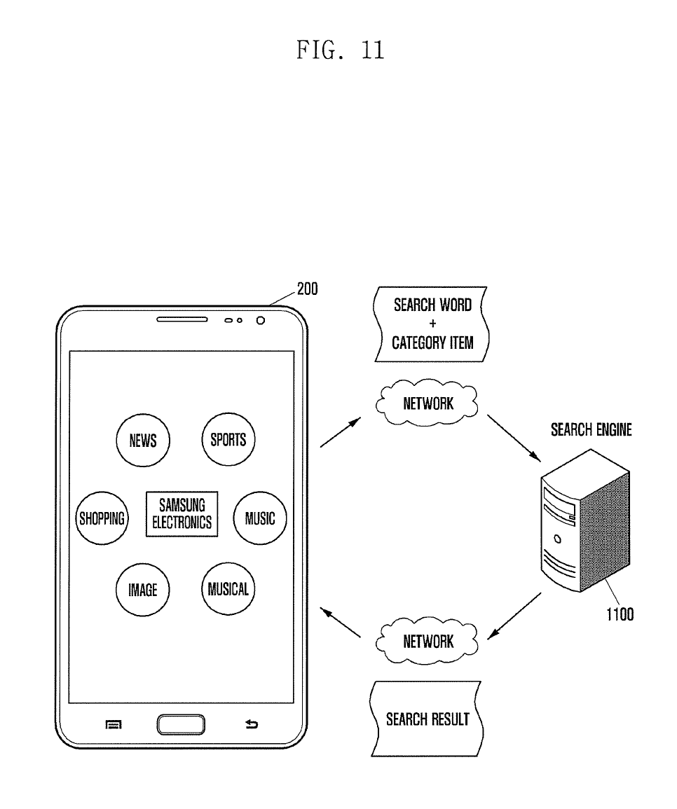

FIG. 11 is a diagram illustrating a system for searching for a search word using a search server 1110 by the electronic device 200 according to various embodiments of the present disclosure.

Referring to FIG. 11, the search system includes an electronic device 200, a network, and a search server 1100. The network 162 is a telecommunication network. The communication network includes at least one of a computer network, the internet, the Internet of things, and a telephone network. The search server 1110 is managed with search engines such as GOOGLE, NAVER, Daum, and YAHOO.

The electronic device 200 transmits a search word acquired from the user and a category item matched with the search word to the search server 1100 through a network. The search server 1100 receives the search word and the category item from the electronic device 200 and performs a search with a search word in the category item. The search server 1100 transmits the search result for the search word to the electronic device 200 through a network. The electronic device 200 displays the search result for the search word received from the search server 1100 on the display 260. In this case, the electronic device 200 provides a result screen as illustrated in FIG. 10.

According to various embodiments, at least some of the devices (for example, modules or functions thereof) or the method (for example, operations) according to the present disclosure is implemented by a command stored in a computer-readable storage medium in a programming module form. When he command is executed by one or more processors (for example, the processor 210), the one or more processors executes a function corresponding to the command. The computer-readable storage medium can be, for example, the memory 230. At least a part of the programming module can be implemented (for example, executed) by, for example, the processor 210. At least some of the programming modules include, for example, a module, a program, a routine, a set of instructions or a process for performing one or more functions.

The computer readable recording medium includes magnetic media such as a hard disc, a floppy disc, and a magnetic tape, optical media such as a compact disc read only memory (CD-ROM) and a digital versatile disc (DVD), magneto-optical media such as a floptical disk, and hardware devices specifically configured to store and execute program commands, such as a read only memory (ROM), a random access memory (RAM), and a flash memory. In addition, the program instructions include high class language codes, which can be executed in a computer by using an interpreter, as well as machine codes made by a compiler. The aforementioned hardware device can be configured to operate as one or more software modules in order to perform the operation of the present disclosure, and vice versa.

The programming module according to the present disclosure includes one or more of the aforementioned components or may further include other additional components, or some of the aforementioned components may be omitted. Operations executed by a module, a programming module, or other component elements according to various embodiments of the present disclosure are executed sequentially, in parallel, repeatedly, or in a heuristic manner. Further, some operations are executed according to another order or may be omitted, or other operations can be added.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures can be implemented in hardware, software or a combination of both and can be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” includes hardware in the disclosure. Under the broadest reasonable interpretation, the appended claims are statutory subject matter in compliance with 35 U.S.C. §101.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A search method of an electronic device, comprising:
displaying a search word area and at least one category area including a category item;
acquiring a search word;
displaying the acquired search word in the search word area;
matching the search word area with the one or more category areas according to an input of the user; and
performing a search with the search word based on a category item included in the matched at least one category area.

2. The search method of claim 1, wherein the matching of the search word area further comprises moving the one or more category areas including the category item and providing at least a part of the at least one category area in the search word area.

3. The search method of claim 1, wherein the matching of the search word area further comprises moving the search word area and providing at least a part of the search word area in the one or more category areas.

4. The search method of claim 1, wherein the matching of the search word area further comprises moving the search word area until the input of the user is ended and providing at least a part of the search word area in the two or more category areas.

5. The search method of claim 1, further comprising displaying a search result for the search word.

6. The search method of claim 1, further comprising setting the one or more category areas and a category item included in the one or more category areas based on the acquired search word.

7. The search method of claim 6, wherein the setting of the one or more category areas and the category item further comprises associating the search word with at least one category area including the category item based on the number of searches for the search word and the search result.

8. The search method of claim 7, wherein the setting of the one or more category areas and the category item further comprises, if the searched word is acquired, providing the one or more category areas associated with the acquired search word and a category item included in the one or more category areas.

9. The search method of claim 6, wherein the setting of the one or more category areas and the category item further comprises setting at least one of the number, the location, the size, the color, and the contrast of the one or more category areas, based on the number of searches for the search word and the search result.

10. The search method of claim 1, wherein the performing of the search further comprises:
transmitting the search word and a category item included in at least one category area matched with the search word;
receiving the search result based on the search word and a category matched with the search word from the search server; and
displaying the received search result.

11. An electronic device comprising:
a display configured to display a search word area and at least one category area including a category item;
a processor configured to:
acquire a search word,
match the search word area with the one or more category areas according to an input of the user, and
perform a search based on a category item included in the matched at least one category area.

12. The electronic device of claim 11, wherein the processor is configured to move the one or more category areas including the category item and provide at least a part of the one or more category areas in a part of the search word area.

13. The method of claim 11, wherein the processor is configured to move the search word area and provide at least a part of the search word area in the one or more category areas.

14. The electronic device of claim 11, wherein the processor is configured to move the search word area until the input of the user is ended and provide at least a part of the search word area in the two or more category areas.

15. The electronic device of claim 11, wherein the display is configured to display a result according to the search result for the search word.

16. The electronic device of claim 11, wherein the processor is configured to set the one or more category areas and a category item included in the one or more category areas based on the acquired search word.

17. The electronic device of claim 16, wherein the processor is configured to associate the search word with at least one category area including the category item based on the number of searches for the search word and the search result.

18. The electronic device of claim 17, wherein if the searched word is acquired, the display provides the at least one category area associated with the acquired search word and a category item included in the at least one category area.

19. The electronic device of claim 16, wherein the processor is configured to set at least one of the number, the location, the size, the color, and the contrast of the one or more category areas, based on the number of searches for the search word and the search result.

20. The electronic device of claim 11, further comprising:
a communication module configured to transmit the search word and the category item included in the one or more category areas matched with the search word to a server, and receive the search result based on the search word and the category matched with the search word from the search server; and
a display configured to display the received search result.
